(19) United States
(12) Patent Application Publication
(10) Pub. No.: US 2003/0008101 A1
(43) Pub. Date: Jan. 9, 2003

(54) Molded product with rigid core and elastomeric outer element

(76) Inventor: Scott Henderson, Brooklyn, NY (US)

Correspondence Address: SEYFARTH SHAW, 55 EAST MONROE STREET, SUITE 4200, CHICAGO, IL, 60603-5803, US

(21) Appl. No.: 09/899,674

(22) Filed: Jul. 5, 2001

(51) Int. Cl. B32B 3/06

(52) U.S. Cl. 428/99; 428/68

(57) ABSTRACT

A molded plastic bathroom organizer fixture has a core body formed of a relatively rigid first plastic material and an outer body covering outer surface portions of the core body and formed of an elastomeric material overmolded on the core body and providing improved gripping of supported articles and frictional surfaces to enhance grasping by a user. The fixture is mountable on a wall surface by one or more such cups, which may be unitary with the outer body or may form part of a separate mounting structure engageable with the fixture in either pivoting or longitudinally sliding relationship therewith. The outer body may be light-transmitting to permit viewing therethrough of the core body, which may be formed of a visually distinguishable material. Portions of the outer surface of the core body may remain exposed. Each suction cup is oval and oriented with its long axis vertical or nearly vertical in use. A number of different embodiments are disclosed.

### BACKGROUND

This application relates to molded plastic products and, in particular, to houseware products, such as those which can be used in a bathroom for organizing personal toiletry items or the like, although it will be appreciated that the principles of the invention are applicable to other types of products.

Household products are commonly made of various types of plastic materials. In particular, it is known to provide various types of article-supporting or organizer products molded of suitable plastic materials. A number of such organizers have been provided for use in bathroom settings. Heretofore, such products have been molded of a single plastic material, typically a rigid plastic material. Various types of mounting arrangements for such products have been provided, including suction cups secured to the product by adhesive or other suitable means for mounting the product on a wall surface. However, such prior plastic products have been relatively slippery, both for a user to handle and in terms of retaining articles thereon.

It is known to make other types of molded products by a bi-molding technique wherein two different types of materials are used, one forming an inner body and another forming an outer skin element, the two materials being selected to perform different functions. For example, a rigid core may be provided for dimensional stability, strength and the like, while a softer outer material may be provided for other reasons, such as marring resistance, ergonomics or the like. However, such bi-molding techniques have not heretofore been provided in products such as household organizers.

### SUMMARY

This application discloses an improved wall-mountable molded product which avoids the disadvantages of prior such products while affording additional structural and operating advantages.

An important aspect is the provision of a wall-mountable product with an inner relatively rigid core body and a more flexible outer body and wall-mountable by means of one or more suction cups.

A further aspect is the provision of a product of the type set forth, wherein the outer body is overmolded on the core body.

Another aspect is the provision of a product of the type set forth, wherein the suction cup is unitary with the outer body.

A still further aspect is the provision of a product of the type set forth, wherein the suction cup is movable relative to other portions of the product.

Certain ones of these and other aspects may be attained by providing a wall-mountable product comprising: a unitary one-piece core body formed of a relatively rigid first plastic material, a unitary one-piece outer body covering outer surface portions of the core body and formed of an elastomeric material, and a suction cup projecting from the core body for attaching the product to a wall surface and formed of the elastomeric material.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of a bathroom hook;

FIG. 2 is a front elevational view of the hook of FIG. 1;

FIG. 3 is a bottom plan view of the hook of FIG. 1;

FIG. 4 is a view in vertical section taken generally along the line 4-4 in FIG. 2;

FIG. 5 is a view in vertical section taken generally along the line 5-5 in FIG. 3;

FIG. 6 is a perspective view of a toothbrush/toothpaste holder;

FIG. 7. is a front elevational view of the holder of FIG. 6;

FIG. 8 is a view in vertical section taken along the line 8-8 in FIG. 7;

FIG. 9 is a view in horizontal section taken generally along the line 9-9 in FIG. 7;

FIG. 10 is a view in vertical section taken generally along the line 10-10 in FIG. 9;

FIG. 11 is a perspective view of a soap dish;

FIG. 12 is a front elevational view of the dish of FIG. 11;

FIG. 13 is a view in vertical section taken generally along the line 13-13 in FIG. 12;

FIG. 14 is a view in vertical section taken generally along the line 14-14 in FIG. 13;

FIG. 15 is a top plan view of another embodiment of soap dish;

FIG. 16 is a front elevational of the soap dish of FIG. 15;

FIG. 17 is a view in vertical section taken generally along the line 17-17 in FIG. 15;

FIG. 18 is a view in vertical section taken generally along the line 18-18 in FIG. 16;

FIG. 19 is a top plan view of corner tray;

FIG. 20 is a fragmentary view in vertical section taken generally along the line 20-20 in FIG. 19;

FIG. 21 is a view in vertical section taken generally along the line 21-21 in FIG. 19;

FIG. 22 is a front elevational view of a mirror assembly;

FIG. 23 is a view in horizontal section taken generally along the line 23-23 in FIG. 22; and

FIG. 24 is a view in vertical section taken generally along the line 24-24 in FIG. 22.

### DETAILED DESCRIPTION

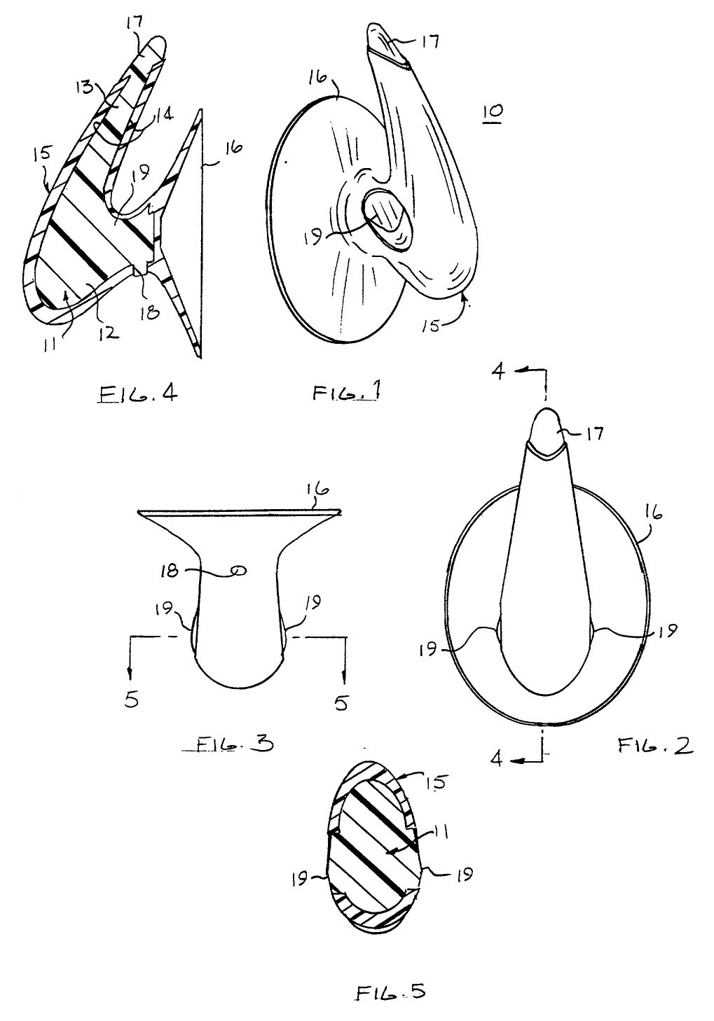

Referring to FIGS. 1-5, there is illustrated a bathroom fixture product in the nature of a hook 10 having a core body 11 formed of a relatively rigid plastic material and having a relatively thick base portion 12 and a tapered prong 13. The core body 11 has an outer surface which is recessed or undercut, as at 14, the recessed portions being covered by an outer body 15 formed of a suitable thermoplastic elastomeric material which is overmolded on the core body 11. The outer body 15 extends beyond the distal end of the base portion 12 and forms a flexible and resilient suction cup 16 for attachment of the hook 10 to an associated wall surface, in a known manner. The unrecessed portions of the outer surface of the core boy 11, including a tip 17 of the prong 13, a lug 18 on the underside of the base portion 12 near its distal end, and portions 19 along the side surfaces of the base portion 12, remain exposed and uncovered by the outer body 15.

The core body 11 may be formed of a hard PVC, polypropylene or other suitable moldable plastic material, while the outer body 15 may be formed of a soft PVC material or a thermoplastic rubber-like material, such as that sold under the trade name SANTOPRENE. The outer body 15 provides a frictional gripping surface to enhance gripping of articles hung on the hook 10. The outer body 15 may be light-transmitting, either translucent or transparent, so that the covered portions of the core body 11 may be viewed therethrough. In this regard, the core body 11 may be formed of a material visually distinguishable from the outer body 15. For example, the core body 11 could be colored while the outer body 15 is clear. The suction cup 16 is preferably oval in shape, with its long axis disposed substantially vertically in use, as illustrated in FIG. 2.

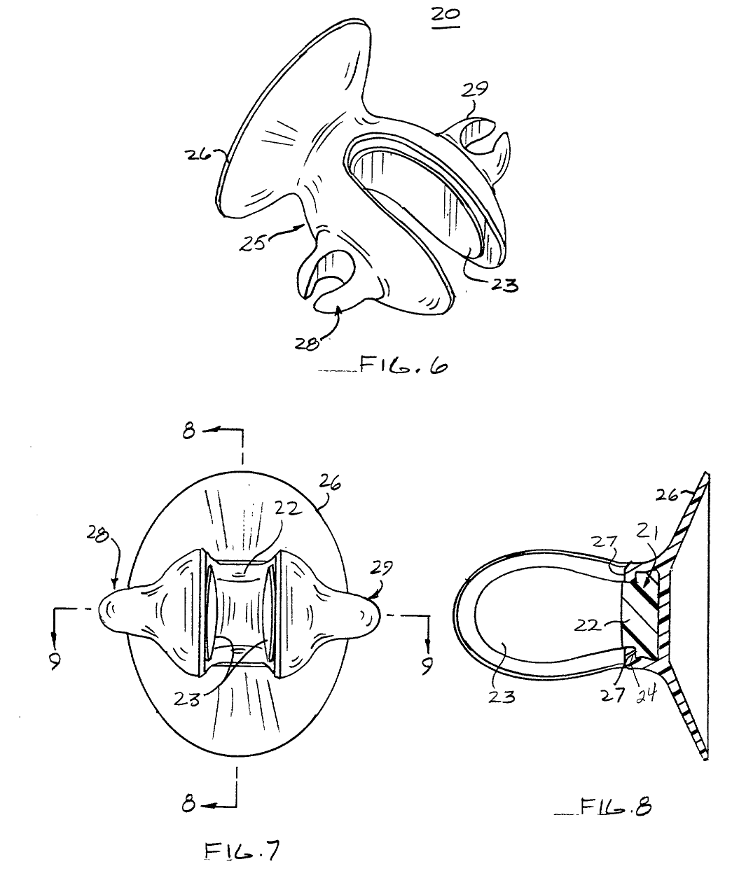

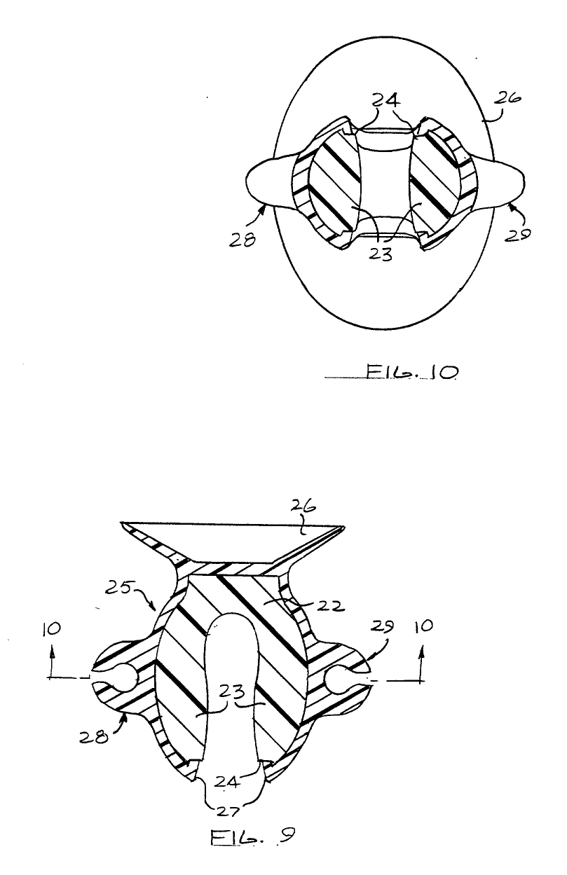

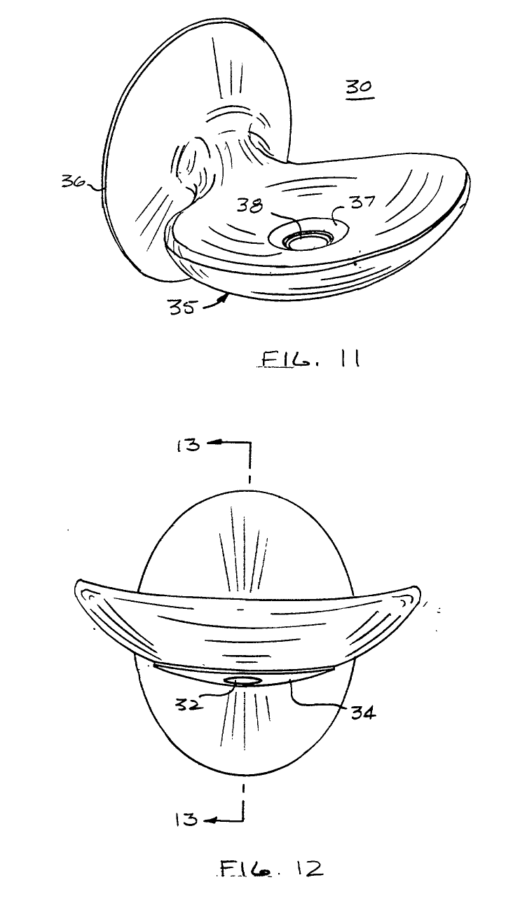

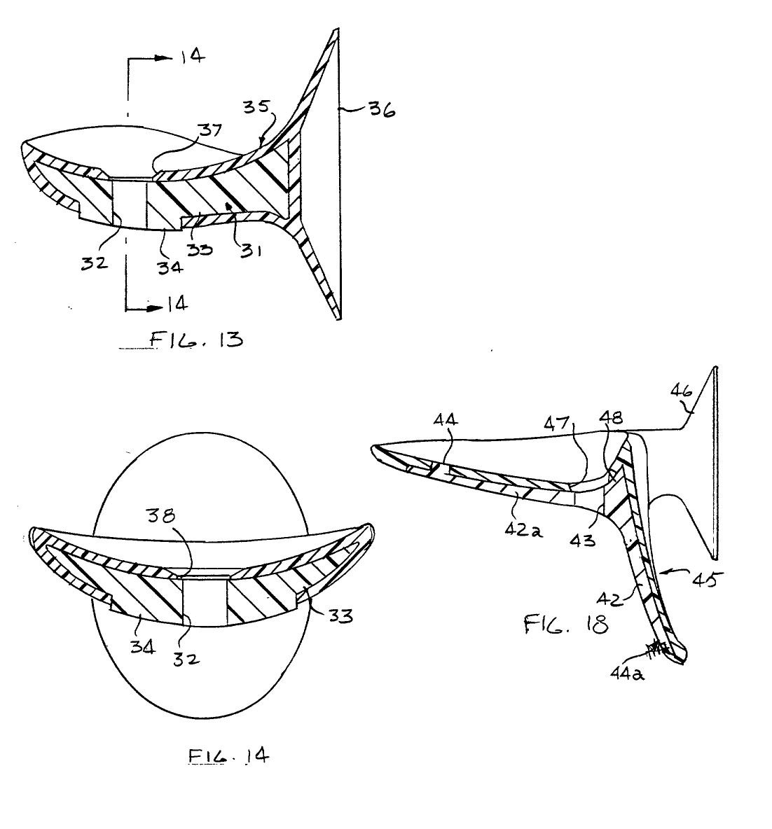

Referring now to FIGS. 6-10, there is illustrated another embodiment of dual-molded plastic product, in the form of another type of bathroom organizer fixture, viz., a toothpaste/toothbrush holder 20. The holder 20 has a relatively rigid core body 21 which is generally clevis-shaped, having a base 22 and a pair of laterally-spaced arms 23 projecting forwardly therefrom. The core body 21 has an outer surface with peripheral recesses 24 formed therein. Most of the outer surface of the core body 21, except for the region between the arms 23, is covered by an outer body 25 formed of a thermoplastic elastomeric material, which may be overmolded on the core body 21. A portion of the outer body 25 projects rearwardly from the base 22 of the core body 21 and forms a flexible and resilient suction cup 26. The outer body 25 includes peripheral lips 27 which engage in the peripheral recesses 24 of the core body 21. Also unitary with the outer body 25 and respectively projecting laterally outwardly from the arms 23 are generally C-shaped holder brackets 28 and 29.

The core body 21 and the outer body 25 may, respectively, be formed of the same types of materials as the core body 11 and outer body 15, described above. Also, the outer body 25 may be light-transmitting and the core body 21 may be visually distinguishable therefrom in the manner described above in connection with the hook 10. The gap between the arms 23 is dimensioned for receiving and supporting an associated toothpaste tube (not shown). The arms of the holder brackets 28 and 29 are flexible and resilient and spreadable so that each holder may receive between the arms thereof the handle of an associated toothbrush (not shown). The suction cup 26 is oval in shape with its long axis preferably disposed vertically in use.

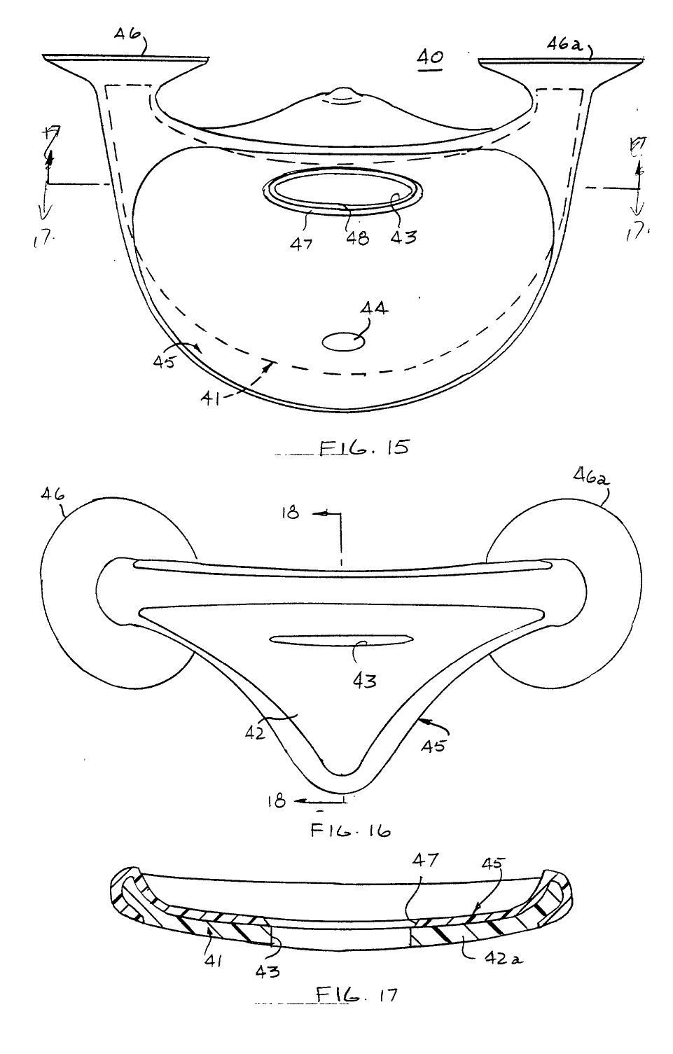

Referring now to FIGS. 11-14, there is illustrated another embodiment of dual-molded product, in the form of another bathroom organizer fixture, viz., a small soap dish 30. The dish 30 has a generally dish-shaped core body 31 molded of a suitable relatively rigid plastic material and having a drain hole 32 formed therethrough. The outer surface of the core body 31 is recessed or undercut along the bottom thereof, as at 33, leaving a projecting land 34 generally oval in shape. The dish 30 includes an outer body 35 formed of a thermoplastic elastomeric material and overmolded on the core body 31 so as to cover most of the outer surface thereof, except for the land 34. A portion of the outer body 35 projects rearwardly from the core body 31 and forms a flexible and resilient suction cup 36 which is oval in shape. The portion of the outer body 35 covering the upper surface of the core body 31 has a beveled hole 37 therethrough aligned with the hole 32 and leaving an exposed ring 38 of the upper surface of the core body 31 around the hole 32. In use, the long axis of the suction cup 36 is disposed substantially vertically, i.e., substantially parallel to the axis of the hole 32. The materials of the core body 31 and the outer body 35 may be the same as and have the same types of characteristics as the materials for the corresponding portions of the products 10 and 30 described above. The frictional gripping character of the outer body 35 will inhibit slipping of a bar of soap supported on the dish 30.

Referring now to FIGS. 15-18, there is illustrated a larger soap dish 40 having a generally L-shaped core body 41 with a generally triangular depending base 42 and a generally oval article support 42a having an elongated oval drain hole 43 formed therethrough adjacent to the base 42. Projecting upwardly from the article support 42a is an oval lug or land 44 which may display a logo or the like. A recess 44a (FIG. 18) is formed in the front surface of the base 42 around the periphery thereof. The outer surface of the core body 41, except for the lug 44, the underside of the support 42a and the front side of the base 42, is covered with an outer body 45 formed of a thermoplastic elastomeric material which is overmolded on the core body 41. The outer body 45 covers the peripheral recess 44a of the base 42 and the front edge of the support 42a. A portion of the outer body 45 projects rearwardly from the core body 41 at the opposite ends of the support 42a and forms two flexible and resilient suction cups 46 and 46a, each oval in shape and having a long axis inclined slightly to the vertical in use, as shown in FIG. 16. Formed through the outer body 45 is an oval, tapered or beveled drain hole 47 which surrounds the hole 43 and leaves uncovered an annular exposed ring 48 of the upper surface of the support 42a. The materials and functioning of the dish 40 are substantially the same as those of the dish 30, described above.

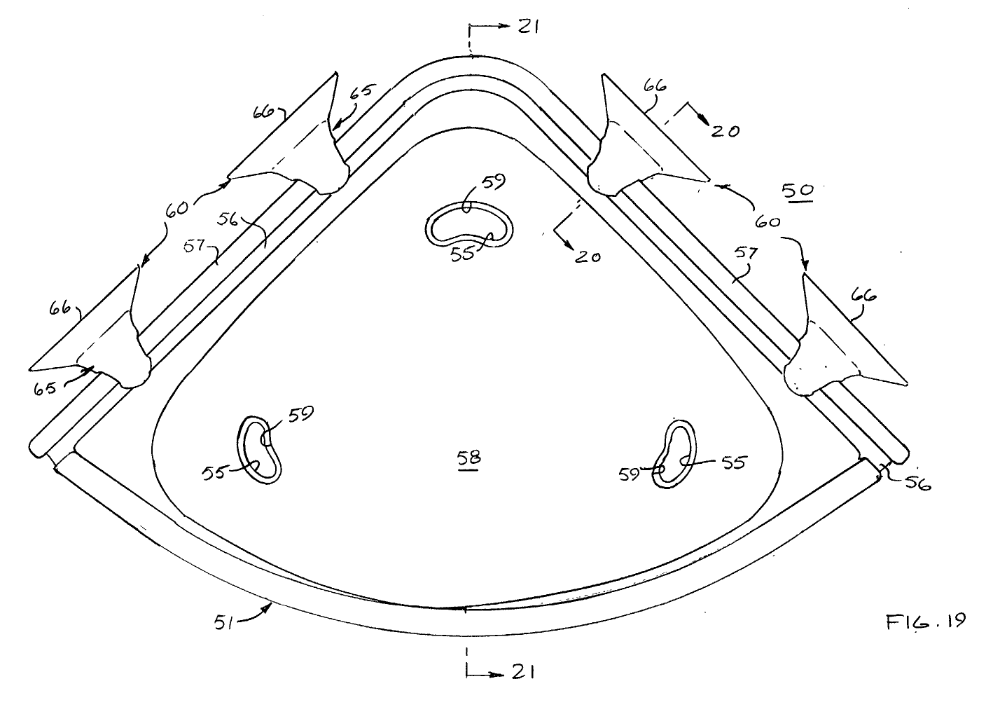

Referring now to FIGS. 19-21, there is illustrated another embodiment of bi-molded product in the nature of a bathroom organizer fixture, viz., a corner tray 50, which may, for example, be mounted in the corner of a shower stall or the like. The tray 50 includes an article support 51 and a plurality of mounting structures 60 (four shown) detachably connectable to the article support 51 for supporting it on corner walls. The article support 51 has a core body 52 molded of a relatively rigid plastic material and having a generally triangular base 53 integral around its periphery with an upstanding sidewall 54. Drain holes 55 are formed through the base 53 adjacent to the corners thereof. Integral with the upper edge of the side wall 54 and projecting laterally outwardly and downwardly therefrom along two sides of the triangular base 53, is a neck 56 terminating in a thickened, generally rectangular bead 57 along its entire length. The upper surfaces of the base 53, the side wall 54 and the neck 56 are covered with an outer body 58 formed of a thermoplastic elastomeric material which may be overmolded on the core body 52. The outer body 58 has three beveled holes 59 therethrough respectively surrounding the holes 55 in the base 53 and leaving uncovered a narrow ring of the upper surface of the base 53 around each hole.

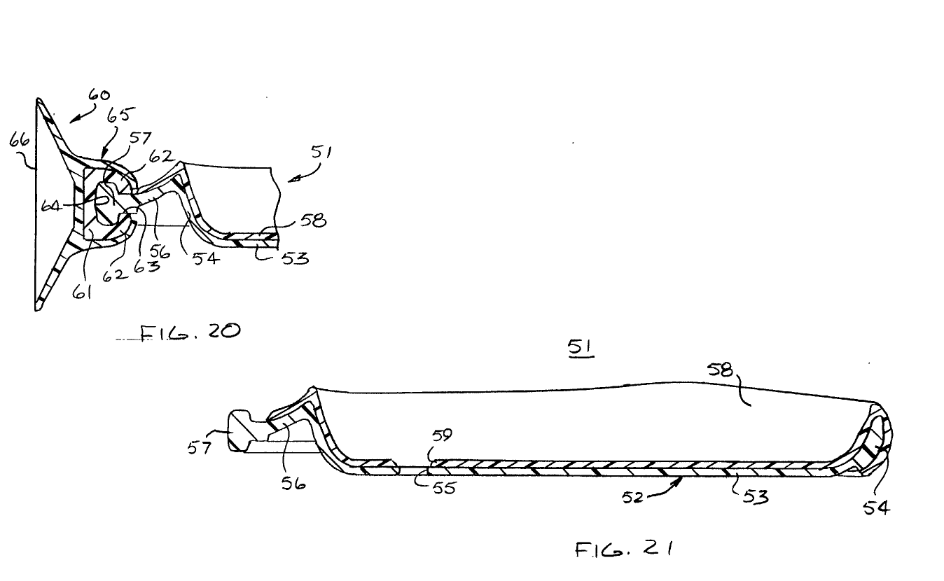

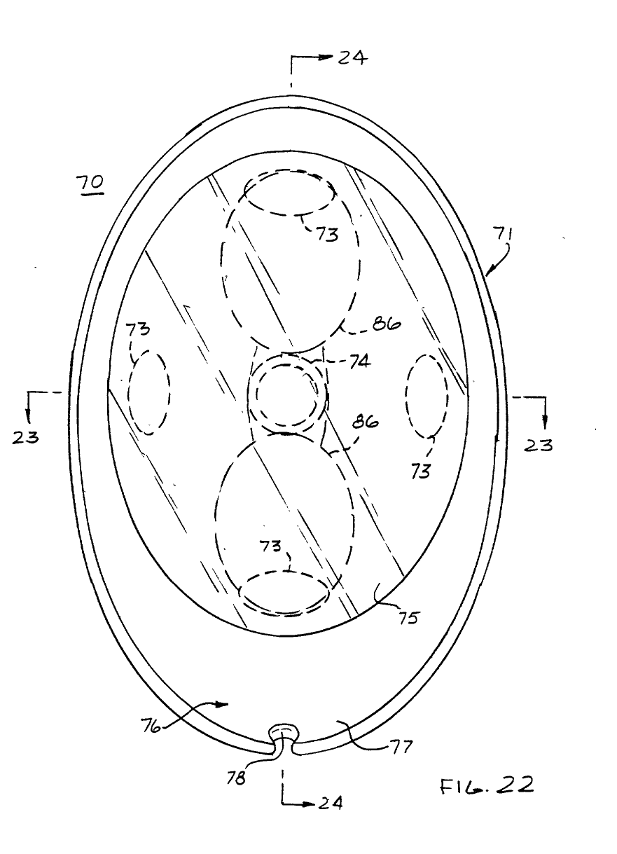

Referring in particular to FIG. 20, each mounting structure 60 has a core body 61, which is generally C-shaped and includes a pair of arms 62 defining a gap 63 therebetween which communicates with a generally rectangular slot 64. The outer surfaces of the core body 61, except for the gap 63 and the slot 64, are covered with an outer body 65 formed of the same material as the outer body 58, a portion of the outer body 65 projecting rearwardly from the core body 61 and defining an oval suction cup 66.

In use, the mounting structures 60 may be slid onto the article support 51 at the ends of the neck 56, with the neck 56 being received in the gap 62 and the bead 57 being received in the slot 64. To facilitate this sliding movement, it will be noted that the distal end portion of the neck 56, which is received between the arms 62, is uncovered by the outer body 58. The materials of the core bodies 52 and 61 and the outer bodies 58 and 65 and the functioning thereof may be substantially the same as for the corresponding portions of the soap dishes 30 and 40, described above.

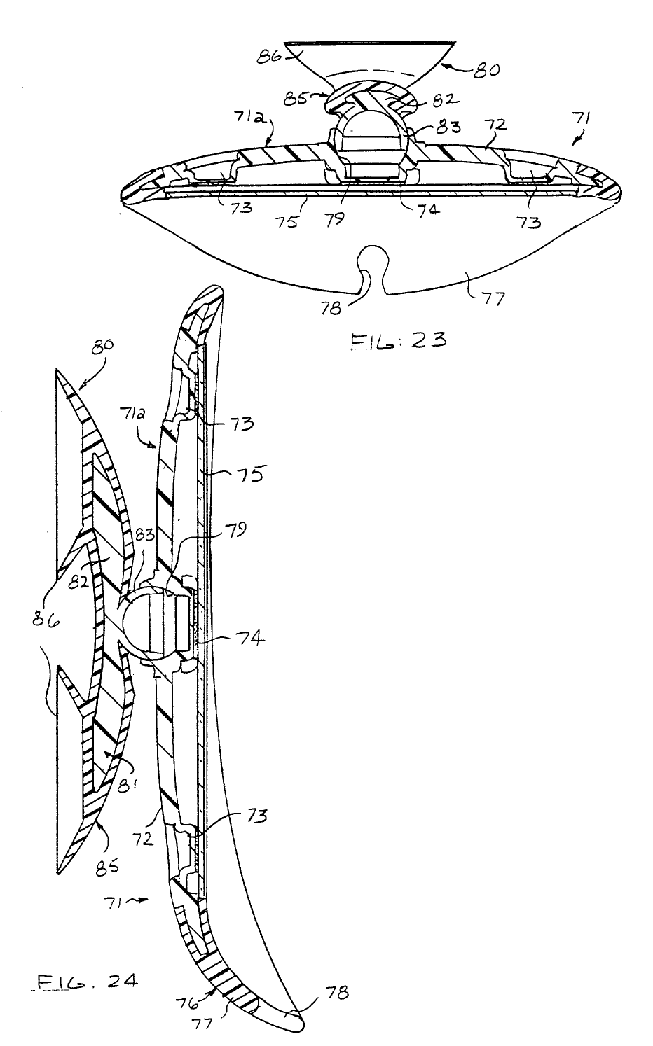

Referring now to FIGS. 22-24, there is illustrated another embodiment of dual-molded product in the nature of a bathroom fixture, viz., a mirror assembly 70. The mirror assembly 70 includes a mirror frame 71 coupled to a mounting structure 80 for supporting the mirror assembly 70 on an associated wall surface. The mirror frame 71 has a core body 71a, which is generally oval in shape and is molded of a relatively rigid plastic material, having a back wall 72 with four generally equiangularly spaced and oval-shaped lugs 73 and a central oval lug 74 projecting forwardly therefrom for supporting the rear surface of a supported oval mirror 75. In particular, the lugs 73 and 74 may be secured to the back of the mirror 75 by suitable adhesive or the like. The periphery of the core body 71a is covered, front and back, by an outer body 76 formed of a thermoplastic elastomeric material and overmolded on the core body 71a. The outer body 76 projects downwardly beyond the lower edge of the core body 71a to define a depending skirt 77 provided with a notch 78 centrally of its lower edge. The outer body 76 engages the mirror 75 around its periphery. Integral with the central lug 74 and projecting slightly rearwardly of the back wall 72 is a part-spherical socket 79.

The mounting structure 80 has a core body 81 which may be formed of the same material as the core body 71 a and includes an elongated base 82 and a part-spherical, hollow connector lug 83 which projects rearwardly from the base 82 centrally thereof and is adapted to be mateably received in the socket 79 for a pivoting, swivel movement relative thereto. The base 82 is covered with an outer body 85, which may be formed of the same material as the outer body 76, and has portions projecting rearwardly adjacent to the opposite ends of the base 82 for defining two flexible and resilient suction cups 86, each of which may be oval in shape with its long axis disposed substantially vertically in use, as illustrated in FIG. 22. The outer bodies 76 and 85 provide frictional gripping surfaces to facilitate mounting and manipulation of the mirror assembly 70. The materials of the core bodies 71a and 81 and the outer bodies 76 and 85 may be of the same corresponding materials for the core bodies and outer bodies as those described above for the products 10, 20, 30, 40, and 50. The notch 78 may support a toothbrush, razor or the like.

While the above-described products all relate to bathroom fixtures, it will be appreciated that the principles described above are also applicable to other types of products.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A wall-mountable product comprising:
a unitary one-piece core body formed of a relatively rigid first plastic material,
a unitary one-piece outer body covering outer surface portions of the core body and formed of an elastomeric material, and
a suction cup projecting from the core body for attaching the product to a wall surface and formed of the elastomeric material.

2. The product of claim 1, wherein the outer body is overmolded on the core body.

3. The product of claim 1, wherein the core body includes exposed outer surface portions not covered by the core body.

4. The product of claim 1, wherein the outer body is light-transmitting to permit viewing of the core body therethrough.

5. The product of claim 4, wherein the core body is visually distinguishable from the outer body.

6. The product of claim 1, wherein the suction cup is unitary with the outer body.

7. The product of claim 1, wherein the suction cup is movably connected to the core body.

8. The product of claim 1, and further comprising at least one additional suction cup.

9. The product of claim 1, wherein at least one of the core body and the outer body includes article-supporting portions.

10. The product of claim 9, wherein each of the core body and the outer body includes article-supporting portions.

11. The product of claim 1, wherein the product is a bathroom fixture.

12. The product of claim 1, wherein the suction cup is oval in shape.

13. The product of claim 12, wherein the suction cup has a long axis oriented vertically in use.

14. A wall-mountable product comprising:
an article support including a first unitary one-piece core body formed of a first relatively rigid plastic material,
a first unitary one-piece outer body covering outer surface portions of the first core body and formed of a first elastomeric material, and
a first connecting portion carried by the first core body; and
mounting structure including a suction cup for attachment to a wall surface,
the mounting structure including a second connecting portion engageable with the first connecting portion for mounting the article support on the associated wall surface.

15. The product of claim 14, wherein the first connecting portion is unitary with the first core body.

16. The product of claim 14, wherein the mounting structure includes a second unitary one-piece core body formed of a second relatively rigid plastic material, and a second unitary one-piece outer body covering outer surface portions of the second core body and formed of a second elastomeric material.

17. The product of claim 16, wherein the second connecting portion is carried by the second core body.

18. The product of claim 16, wherein the first and second relatively rigid plastic materials are the same.

19. The product of claim 16, wherein the first and second elastomeric materials are the same.

20. The product of claim 14, wherein the mounting structure includes at least one additional suction cup.

21. The product of claim 14, wherein the first connecting portion is pivotably movable relative to the second connecting portion.

22. The product of claim 14, wherein the second connecting portion is longitudinally slidably movable relative to the first connecting portion.

23. The product of claim 14, wherein the suction cup is oval in shape.

24. The product of claim 23, wherein the suction cup has a long axis oriented vertically in use.
